(19) United States
(12) Patent Application Publication
(10) Pub. No.: US 2016/0026719 A1
(43) Pub. Date: Jan. 28, 2016

(54) METHODS AND DEVICES FOR SHARING RESOURCES

(71) Applicant: Xiaomi Inc., Beijing (CN)

(72) Inventors: Yuheng Qi, Beijing (CN); Yuan Ren, Beijing (CN); Dailin Jiang, Beijing (CN)

(73) Assignee: Xiaomi Inc.

(21) Appl. No.: 14/724,777

(22) Filed: May 28, 2015

Related U.S. Application Data
(63) Continuation of application No. PCT/CN2014/091751, filed on Nov. 20, 2014.

(30) Foreign Application Priority Data
Jul. 23, 2014 (CN) 201410353008.6

(51) Int. Cl. G06F 17/30

(52) U.S. Cl. CPC G06F 17/30867; G06F 17/30554; G06F 17/30905; G06F 17/30235; G06F 17/30097

(57) ABSTRACT

A method for a resource-requesting device to request a shared resource from a resource-providing device, includes: accessing, via a browser installed on the resource-requesting device, a predetermined service address for sharing resources, the service address pointing to a web-service port of the resource-providing device; receiving a list of shared resources sent by the resource-providing device, the list of shared resources including information regarding at least one shared resource; presenting the list of shared resources in the browser for a user to select a target resource to access; and accessing the target resource according to information regarding the target resource.

### CROSS-REFERENCE TO RELATED APPLICATIONS

This application is a continuation of International Application No. PCT/CN2014/091751, filed Nov. 20, 2014, which is based upon and claims priority to Chinese Patent Application No. 201410353008.6, filed Jul. 23, 2014, the entire contents of all of which are incorporated herein by reference.

### TECHNICAL FIELD

This disclosure generally relates to the field of network technology and, more particularly, to methods and devices for sharing resources via a network.

### BACKGROUND

With the development of network technology, a plurality of terminals can share a network via a network-sharing device such as a router. For example, if a portable Wireless Fidelity (WiFi) device is inserted into a computer to share a network accessed by the computer, a mobile phone can be connected to and access the network.

The computer can share resources with the mobile phone via the network. Conventionally, network-sharing clients need to be installed in both the computer and the mobile phone for them to share the resources. However, installing the network-sharing client occupies the mobile phone's storage space.

### SUMMARY

According to a first aspect of the present disclosure, there is provided a method for a resource-requesting device to request a shared resource from a resource-providing device, comprising: accessing, via a browser installed on the resource-requesting device, a predetermined service address for sharing resources, the service address pointing to a web-service port of the resource-providing device; receiving a list of shared resources sent by the resource-providing device, the list of shared resources including information regarding at least one shared resource; presenting the list of shared resources in the browser for a user to select a target resource to access; and accessing the target resource according to information regarding the target resource.

According to a second aspect of the present disclosure, there is provided a method for a resource-providing device to provide a shared resource to a resource-requesting device, comprising: monitoring the resource-requesting device's access to a predetermined service address for sharing resources, the service address pointing to a web-service port of the resource-providing device; acquiring a list of shared resources including information regarding at least one shared resource; and sending the list of shared resources to the resource-requesting device via the web-service port, so that the resource-requesting device presents the list of shared resources in the browser for a user to select a target resource to access.

According to a third aspect of the present disclosure, there is provided a resource-requesting device, comprising: a processor; and a memory for storing instructions executable by the processor, wherein the processor is configured to: access, via a browser installed on the resource-requesting device, a predetermined service address for sharing resources, the service address pointing to a web-service port of a resource-providing device; receive a list of shared resources sent by the resource-providing device, the list of shared resources including information regarding at least one shared resource; present the list of shared resources in the browser for a user to select a target resource to access; and access the target resource according to information regarding the target resource.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram illustrating an implementation environment of a method for sharing resources, according to exemplary embodiments.

FIG. 2 is a flowchart of a method for sharing resources, according to an exemplary embodiment.

FIG. 3 is a flowchart of a method for sharing resources, according to an exemplary embodiment.

FIG. 4 is a schematic diagram illustrating display of resources, according to an exemplary embodiment.

FIG. 5 is a block diagram of a device for sharing resources, according to an exemplary embodiment.

FIG. 6 is a block diagram of a device for sharing resources, according to an exemplary embodiment.

FIG. 7 is a block diagram of a device for sharing resources, according to an exemplary embodiment.

FIG. 8 is a block diagram of a device for sharing resources, according to an exemplary embodiment.

FIG. 9 is a block diagram of a device for sharing resources, according to an exemplary embodiment.

FIG. 10 is a block diagram of a device for sharing resources, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of methods and devices consistent with aspects related to the invention as recited in the appended claims.

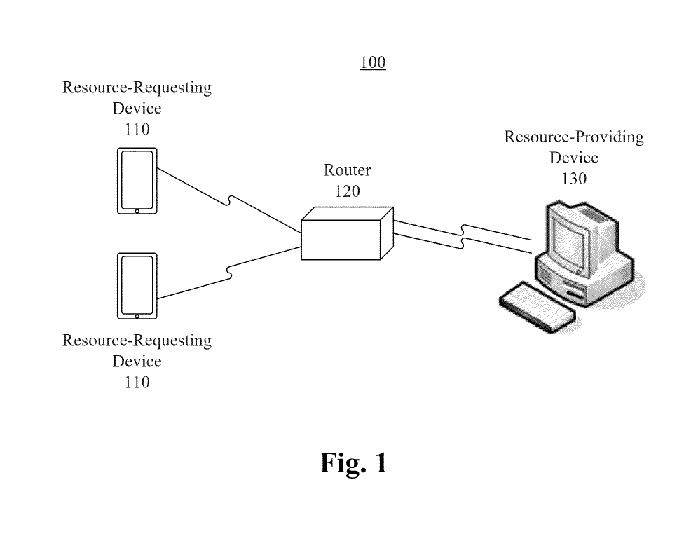

FIG. 1 is a schematic diagram illustrating an implementation environment 100 of a method for sharing resources, according to exemplary embodiments. The implementation environment 100 includes one or more resource-requesting devices 110, a router 120 and a resource-providing device 130.

Each resource-requesting device 110 includes a communication component that performs wired or wireless communication with other devices. The resource-requesting device(s) 110 may each be a telephone, a mobile phone, a tablet computer, etc. Each resource-requesting device 110 is wirelessly connected with the router 120.

The router 120 is configured to establish a communication connection and to facilitate information exchange between the resource-requesting device(s) 110 and the resource-providing device 130. The router 120 may be connected to the resource-providing device 130 in a wired or wireless manner, or may be inserted into the resource-providing device 130 via a Universal Serial Bus (USB) interface. In some embodiments, the resource-requesting device(s) 110 can directly communicate with the resource-providing device 130. Accordingly, the router 120 may not be needed.

The resource-providing device 130 includes a communication component that performs wired or wireless communication with other devices. The resource-providing device 130 is connected to a network and shares the network with the resource-requesting device(s) 110 via the router 120. The resource-providing device 130 may be a telephone, a mobile phone, a tablet computer, etc.

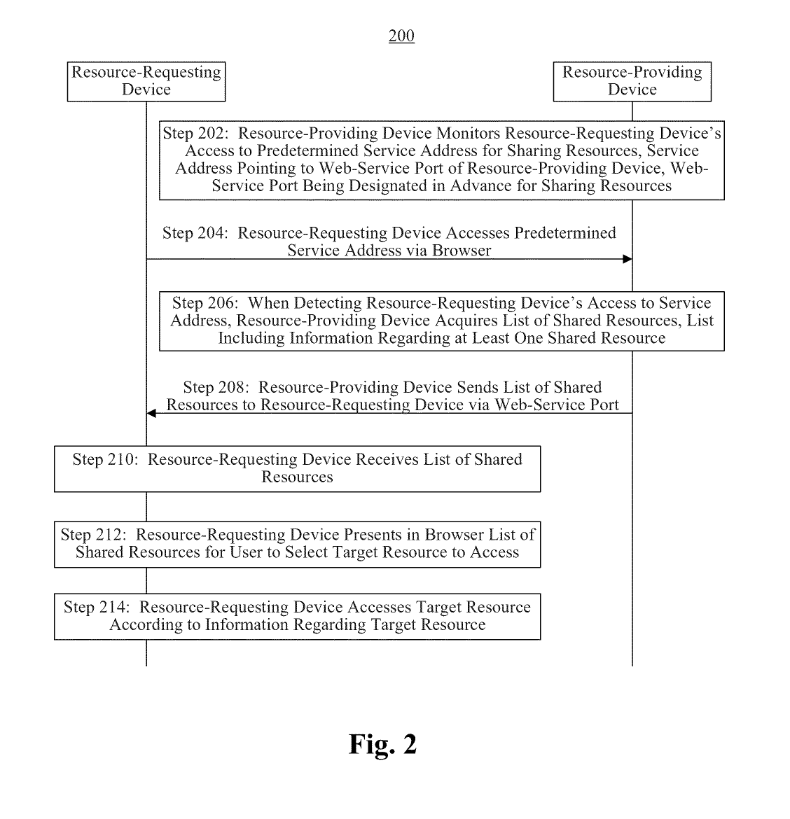

FIG. 2 is a flowchart of a method 200 for sharing resources, according to an exemplary embodiment. As shown in FIG. 2, the method 200 includes the following steps.

In step 202, a resource-providing device monitors a resource-requesting device's access to a predetermined service address for sharing resources. The service address points to a web-service port of the resource-providing device. The web-service port is designated in advance for sharing resources. Shared resources are initially stored in the resource-providing device.

In step 204, the resource-requesting device accesses the predetermined service address for sharing resources via a browser installed on the resource-requesting device. The browser and the web-service port may operate under a same network protocol.

In step 206, when detecting the resource-requesting device's access to the service address, the resource-providing device acquires a list of shared resources. The list includes information regarding at least one shared resource.

In step 208, the resource-providing device sends the list of shared resources to the resource-requesting device via the web-service port.

In step 210, the resource-requesting device receives the list of shared resources.

In exemplary embodiments, the resource-providing device may send the list of shared resources via the web-service port that operates under the same network protocol as the browser of the resource-requesting device, so that the resource-requesting device may receive the list via the browser.

In step 212, the resource-requesting device presents in the browser the list of shared resources for a user to select a target resource to access.

In step 214, the resource-requesting device accesses the target resource according to information regarding the target resource.

Among the above steps, steps 204 and 210-214 may be separately taken as a method for sharing resources used in the resource-requesting device, while steps 202, 206, and 208 may be separately taken as a method for sharing resources used in the resource-providing device.

The method 200 allows the resource-requesting device to access, via its browser, the web-service port of the resource-providing device. Thus, the resource-requesting device no longer needs a network-sharing client to acquire shared resources, thereby saving the storage space to install such client.

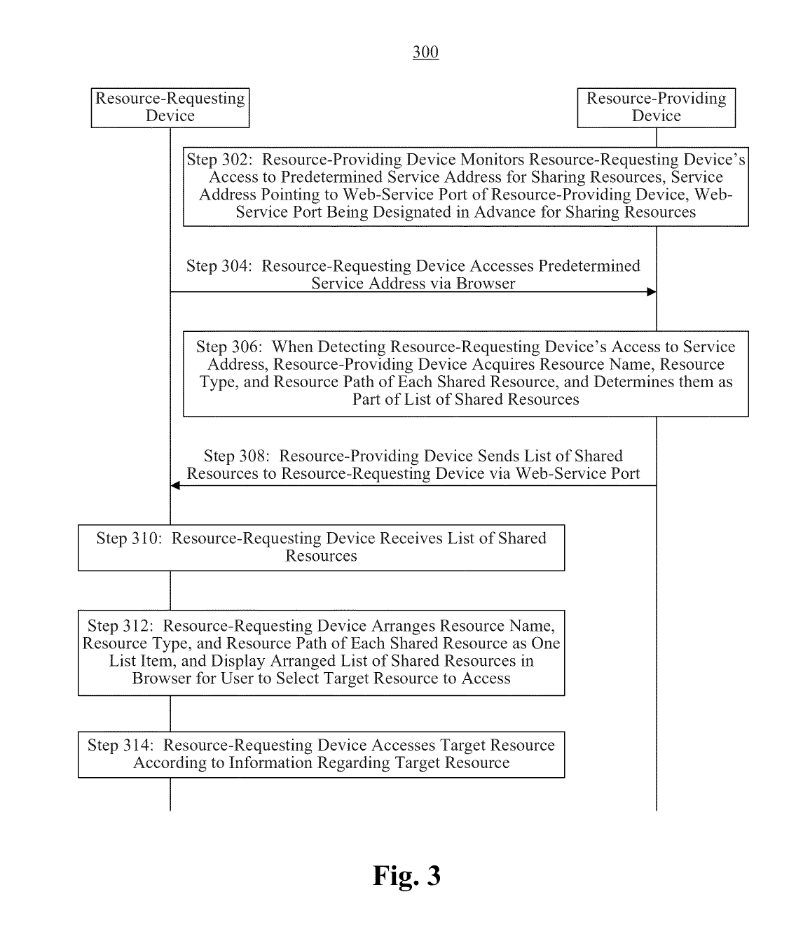

FIG. 3 is a flowchart of a method 300 for sharing resources, according to an exemplary embodiment. As shown in FIG. 3, the method 300 includes the following steps.

In step 302, a resource-providing device monitors a resource-requesting device's access to a predetermined service address for sharing resources. The service address points to a web-service port of the resource-providing device. The web-service port is designated in advance for sharing resources. Shared resources are initially stored in the resource-providing device.

The service address may be a web address recognizable by a browser. In exemplary embodiments, the service address may be preset by users or manufacturers in the resource-requesting device and the resource-providing device. Alternatively, the service address may be determined by the resource-requesting device and the resource-providing device. Moreover, the service address may be allocated by the resource-providing device and then notified to the resource-requesting device. This embodiment does not make specific limitations on the manner of obtaining the service address.

In exemplary embodiments, if the resource-requesting device is not installed with a network-sharing client for acquiring shared resources, the resource-requesting device may not use such client to access the service address when it is connected to a local area network shared by the resource-providing device. However, because the resource-requesting device is usually installed with a browser, the resource-providing device may provide a web-service port operated under a same protocol as the browser, such that the resource-requesting device can access the web-service port and thereby shared resources via the browser. For example, the web-service port may be set to 192.168.123.1:80. This way, the sharing range of the shared resources is expanded as they can be accessed by more resource-requesting devices.

In exemplary embodiments, since the resource-providing device may not determine when the resource-requesting device will access the service address, the resource-providing device needs to monitor the web-service port in order to timely respond to the resource-requesting device's attempt of accessing the shared resources. For example, the resource-providing device may monitor the web-service port through the web services provided by a network-sharing client installed therein.

In step 304, the resource-requesting device accesses the predetermined service address via its browser.

In step 306, when detecting the resource-requesting device's access to the service address, the resource-providing device acquires information regarding a resource name, a resource type and a resource path of each shared resource, and includes the information in a list of shared resources.

In the present embodiment, when the resource-requesting device accesses the service address via the browser, a router may acquire the service address and then access the corresponding web-service port of the resource-providing device. When the resource-providing device detects this access event, it determines that the resource-requesting device needs to acquire shared resources. It then acquires the information regarding each shared resource to obtain the list of shared resources, which includes information regarding at least one shared resource.

In the present embodiment, the information regarding a shared resource includes a resource name, a resource type, and a resource path. The resource name is used to identify the shared resource. The resource type is used to indicate a data type of the shared resource. The resource path is used to indicate a storing address of the shared resource. For example, a shared resource may have a resource name of “image”, a resource type of “picture,” and a resource path of “C:\Documents and Settings.”

In step 308, the resource-providing device sends the list of shared resources to the resource-requesting device via the web-service port.

In step 310, the resource-requesting device receives the list of shared resources.

In exemplary embodiments, the resource-providing device may send the list of shared resources via the web-service port that operates under the same network protocol as the browser of the resource-requesting device, so that the resource-requesting device may receive the list via the browser.

In step 312, the resource-requesting device arranges the information regarding each shared resource in the list as one list item, and displays the arranged list of shared resources in the browser, so that a user can conveniently select a target resource to access.

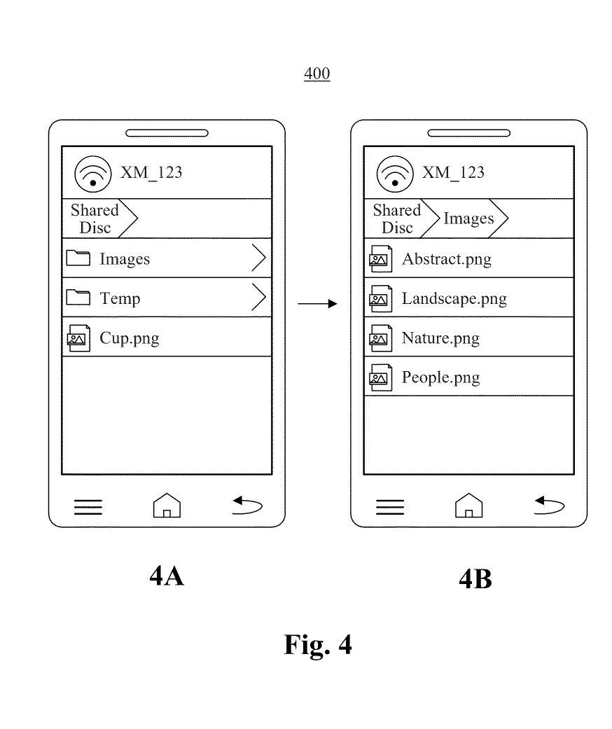

If the resource-requesting device randomly displays resource names, resource types, and resource paths of the shared resources in the browser, the displayed information may be confusing and the user may have to look up each piece of information one by one. This will result in reduced searching efficiency. In the present embodiment, the resource-requesting device may display the list of shared resources according to each shared resource. For example, the resource-requesting device arranges the information regarding each shared resource as one list item. Thus, each list item includes a resource name, a resource type, and a resource path of each shared resource. FIG. 4 is a schematic diagram illustrating display of shared resources on the resource-requesting device, according to an exemplary embodiment. Each row in FIG. 4 is a list item. For example, each of “image,” “temp,” “cup.png,” “abstract.png,” “landscape.png,” “nature.png,” and “people.png” is an independent list item.

In exemplary embodiments, after the resource-requesting device displays the arranged list of shared resources, the user may acquire a shared resource by selecting it, such as by clicking it. The resource-requesting device then determines the selected resource as the target resource and acquires information regarding the target resource, which includes its resource name, resource type, and resource path.

In the present embodiment, the target resource may be a file or a folder. The folder may contain one or more files and/or other folders. Files in a folder are classified according to predetermined classification rules. Because a file may be searched within the smaller range of a folder, there is no need to pooling all the files together and search among them. Thus, the searching efficiency is improved.

In step 314, the resource-requesting device accesses the target resource according to information regarding the target resource.

Depending on the target resource being a folder or a file, the resource-requesting device accesses the target resource in different ways.

Firstly, if the target resource is a folder, step 314, when performed in the resource-requesting device, further includes: 1) sending information regarding the target folder to the resource-providing device via the browser, so that the resource-providing device returns a file directory of the target folder via the web-service port to the resource-requesting device; 2) receiving the file directory, which includes information regarding at least one file contained in the target folder; 3) presenting the file directory in the browser for the user to select a target file to access; and 4) accessing the target file according to information regarding the target file.

In exemplary embodiments, if the resource-providing device enables downloading of all the files in a folder at one time, it may send all the files contained in the target folder to the resource-requesting device via the web-service port. If the resource-providing device only provides downloading of one file in a folder at each time, it may send the file directory of the target folder to the resource-requesting device via the web-service port. The file directory includes information regarding at least one file contained in the target folder. The information includes a file name, a file type, and a file path. The resource-requesting device displays in its browser the file directory in a manner similar to displaying the arranged list of shared resources. The user can select a file from the file directory to access. The resource-requesting device then determines the selected file as a target file, acquires information regarding the target file, and accesses the target file according to the information.

For example, in FIG. 4, the resource-providing device sends information regarding the folders “image”, “temp,” and “cup.png” to the browser. The browser generates and displays a list of shared resources, as illustrated in FIG. 4A. If the user determines that the shared resource to be acquired belongs to the “image” folder, this folder may be selected. Then, the resource-providing device determines the “image” folder as a target resource and sends information regarding this folder to the resource-providing device. The resource-providing device acquires information regarding the files contained in the “image” folder and sends it to the resource-requesting device. Finally, the browser displays a file directory of the “image” folder, as illustrated in FIG. 4B. The information regarding each file is one list item of the file directory.

In exemplary embodiments, if the above user-selected target file is another folder, the resource-requesting device repeats the above-described process until it access a file.

If the file directory includes both files and folders, the resource-providing device may send information regarding the files as well as the folders to the resource-requesting device. Thus, the file directory presented in the browser also includes both files and folders. As illustrated in FIG. 4A, the browser displays the file directory of a shared disc that stores shared resources. This shared disc contains not only the folders “image” and “temp,” but also the file “cup.png.”

Accordingly, if the target resource is a folder, the resource-providing device may perform the following steps: 1) receiving the information regarding the target folder sent by the resource-requesting device; 2) acquiring the file directory of the target folder based on the information; and 3) sending the file directory to the resource-requesting device.

In exemplary embodiments, when receiving the information regarding the target folder, the resource-providing device may send all the files in the target folder to the resource-requesting device. Alternatively and/or additionally, the resource-providing device may acquire the file directory of the target folder and send it to the resource-requesting device. Then the resource-requesting device accesses the files based on the file directory.

Secondly, if the target resource is a file, step 314, when performed in the resource-requesting device, further includes: 1) sending information regarding the target file to the resource-providing device via the browser, so that the resource-providing device returns the target file to the resource-requesting device; and 2) receiving the target file.

Accordingly, the resource-providing device may perform the following steps: 1) receiving the information regarding the target file sent by the resource-requesting device; and 2) sending the target file, acquired based on the information, to the resource-requesting device via the web-service port.

Among the steps described above, steps 304 and 310-314 may be separately taken as a method for sharing resources used in the resource-requesting device, while steps 302, 306 and 308 may be separately taken as a method for sharing resources used in the resource-providing device.

The method 300 allows the resource-requesting device to access, via its browser, the web-service port of the resource-providing device. Thus, the resource-requesting device may not need a network-sharing client to acquire shared resources, thereby saving the storage space. Moreover, the method 300 classifies shared files based on folders, which facilitates searching for a file in the shared files. Thus, the searching efficiency is improved.

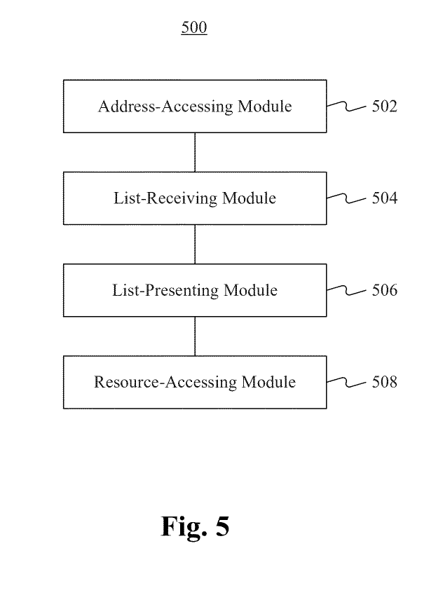

FIG. 5 is a block diagram of a device 500 for sharing resources, according to an exemplary embodiment. For example, the device 500 may be included in a resource-requesting device connected to the same local area network as a resource-providing device. As shown by FIG. 5, the device 500 includes an address-accessing module 502, a list-receiving module 504, a list-presenting module 506, and a resource-accessing module 508.

The address-accessing module 502 is configured to access, via a browser, a predetermined service address for sharing resources. The service address points to a web-service port of the resource-providing device, via which the resource-providing device returns a list of shared resources to the resource-requesting device. The web-service port is designated in advance for sharing resources. Shared resources are initially stored in the resource-providing device.

The receiving module 504 is configured to receive the list of shared resources. The list includes information regarding at least one shared resource.

The list-presenting module 506 is configured to present the list of shared resources in the browser for a user to select a target resource to access.

The resource-accessing module 508 is configured to access the target resource according to information regarding the target resource.

The device 500 accesses the web-service port of the resource-providing device via the browser. Thus, the resource-requesting device may not need a network-sharing client to acquire shared resources, thereby saving the storage space.

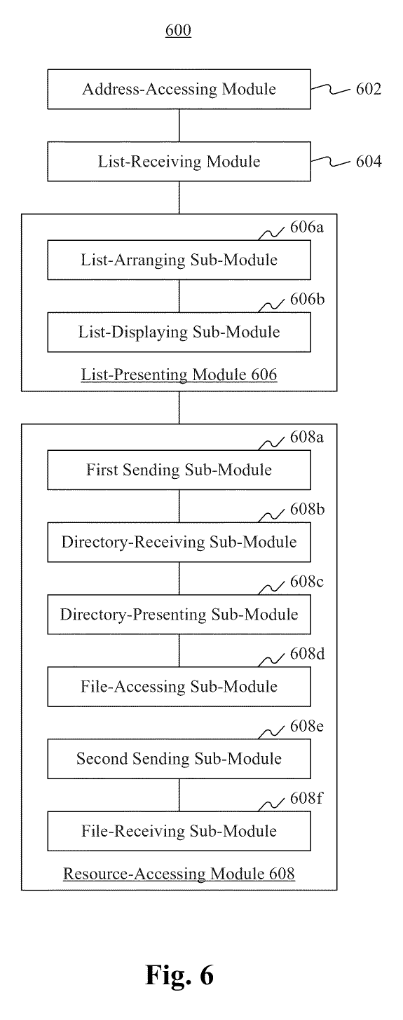

FIG. 6 is a block diagram of a device 600 for sharing resources, according to an exemplary embodiment. For example, the device 600 may be included in a resource-requesting device connected to the same local area network as a resource-providing device. As shown by FIG. 6, the device 600 includes an address-accessing module 602, a list-receiving module 604, a list-presenting module 606, and a resource-accessing module 608, similar to the address-accessing module 502, the list-receiving module 504, the list-presenting module 506, and the resource-accessing module 508 (FIG. 5), respectively.

In exemplary embodiments, the list-presenting module 606 may include a list-arranging sub-module 606a and a list-displaying sub-module 606b. The list-arranging sub-module 606a is configured to arrange information regarding each shared resource in the list of shared resources as one list item. The information regarding each shared resource includes a resource name, a resource type, and a resource path of the shared resource. The list-displaying sub-module 606b is configured to display the arranged list of shared resources in the browser.

In exemplary embodiments, if the target resource is a folder, the resource-accessing module 608 may include a first sending sub-module 608a, a directory-receiving sub-module 608b, a directory-presenting sub-module 608c, and file-accessing sub-module 608d. The first-sending sub-module 608a is configured to send information regarding the folder to the resource-providing device via the browser, so that the resource-providing device returns a file directory of the folder to the resource-requesting device via the web-service port. The directory-receiving sub-module 608b is configured to receive the file directory. The file directory includes information regarding at least one file contained in the folder. The directory-presenting sub-module 608c is configured to present the file directory in the browser for a user to select a target file to access. The file-accessing sub-module 608d is configured to access the target file according to information regarding the target file.

In exemplary embodiments, if the target resource is a file, the resource-accessing module 608 may include a second sending sub-module 608e and a file-receiving sub-module 608f. The second sending sub-module 608e is configured to send information regarding the file to the resource-providing device via the browser, so that the resource-providing device returns the file to the resource-requesting device via the web-service port. The file-receiving sub-module 608f is configured to receive the file.

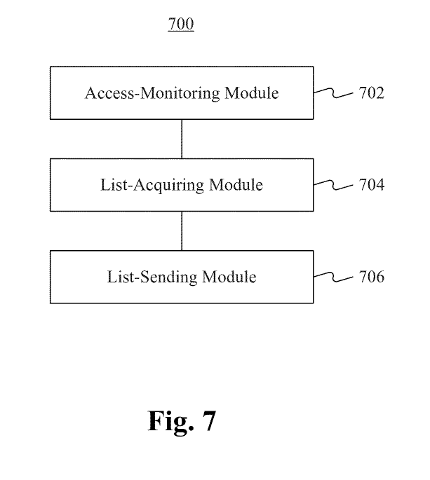

FIG. 7 is a block diagram of a device 700 for sharing resources, according to an exemplary embodiment. For example, the device 700 may be included in a resource-providing device connected to the same local area network as a resource-requesting device. As shown by FIG. 7, the device 700 includes an access-monitoring module 702, a list-acquiring module 704, and a list-sending module 706.

The access-monitoring module 702 is configured to monitor the resource-requesting device's access to a predetermined service address for sharing resources. The service address points to a web-service port of the resource-providing device. The web-service port is designated in advance for sharing resources. The shared resources are initially stored in the resource-providing device.

The list-acquiring module 704 is configured to acquire a list of shared resources, when the access-monitoring module 702 detects the resource-requesting device's access to the predetermined service address. The list of shared resources includes information regarding at least one shared resource.

The list-sending module 706 is configured to send the list of shared resources to the resource-requesting device via the web-service port. The resource-requesting device then presents the list of shared resources in the browser for a user to select a target resource, and access the target resource according to information regarding the target resource.

The device 700 communicates with the browser of the resource-receiving device via the web-service port. Thus, the resource-requesting device may not need a network-sharing client to acquire shared resources, thereby saving the storage space.

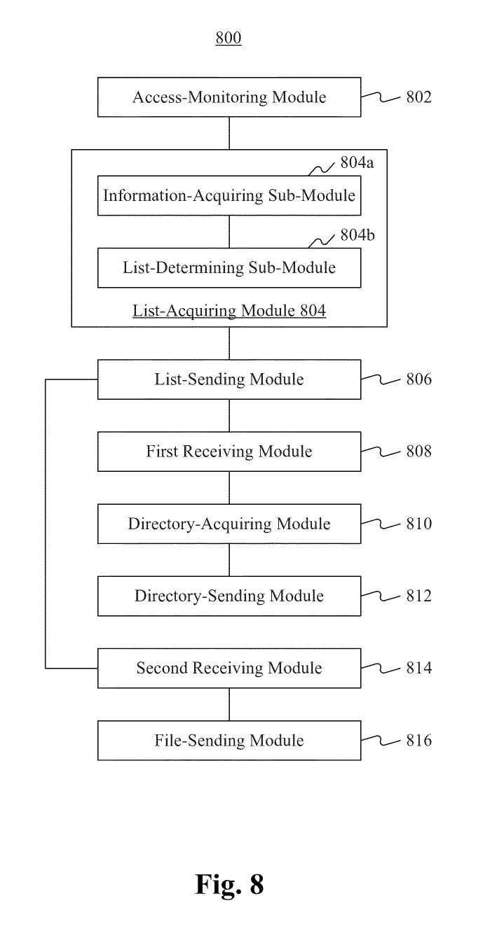

FIG. 8 is a block diagram of a device 800 for sharing resources, according to an exemplary embodiment. For example, the device 800 may be included in a resource-providing device connected to the same local area network as a resource-requesting device. As shown by FIG. 8, the device 800 includes an access-monitoring module 802, a list-acquiring module 804, and a list-sending module 806, similar to the access-monitoring module 702, the list-acquiring module 704, and the list-sending module 706 (FIG. 7), respectively.

In exemplary embodiments, the list-acquiring module 804 may include an information-acquiring sub-module 804a and a list-determining sub-module 804b. The information-acquiring sub-module 804a is configured to acquire a resource name, a resource type, and a resource path of each shared resource. The list-determining sub-module 804b is configured to determine the acquired resource names, resource types, and resource paths as part of the list of shared resources.

In exemplary embodiments, if the target resource is a folder, the device 800 may further include a first receiving module 808, a directory-acquiring module 810, and a directory-sending module 812. The first receiving module 808 is configured to receive information regarding the folder. The information is sent by the resource-requesting device via the browser. The directory-acquiring module 810 is configured to acquire a file directory of the folder based on the information regarding the folder. The file directory includes information regarding at least one file contained in the folder. The directory-sending module 812 is configured to send the file directory to the resource-requesting device. The resource-requesting device then presents the file directory in the browser for the user to select a target file, and access the target file according to information regarding it.

In exemplary embodiments, if the target resource is a file, the device 800 may further include a second receiving module 814 and a file-sending module 816. The second receiving module 814 is configured to receive information regarding the file. The information is sent by the resource-requesting device via its browser. The file-sending module 816 is configured to send the file, acquired based on the information regarding the file, to the resource-requesting device.

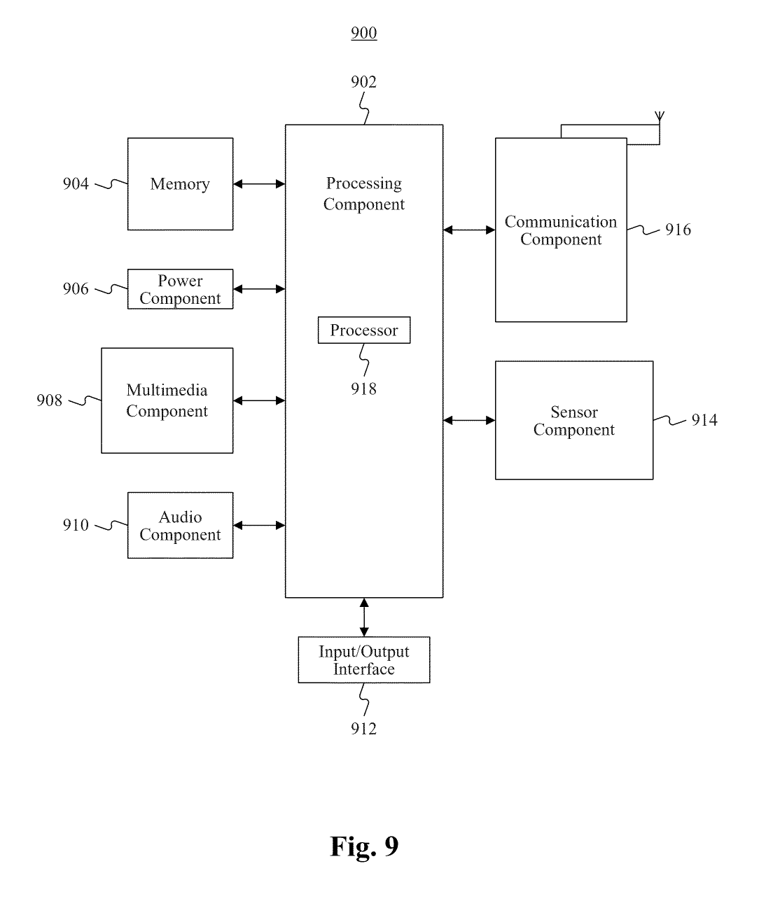

FIG. 9 is a block diagram of a device 900 for sharing resources, according to an exemplary embodiment. For example, the device 900 may be any of the above described resource-requesting devices, such as a mobile phone, a digital broadcast terminal, a messaging device, a gaming console, a tablet, a medical device, exercise equipment, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 918 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or may have focus and optical zoom capability.

The audio component 910 is configured to output and/or input audio signals. For example, the audio component 910 includes a microphone configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect open/closed statuses of the device 900, and relative positioning of components, such as the display and the keypad. The sensor component 914 may also detect position changes of the device 900 or its components, presence or absence of user contacts with the device 900, orientation or acceleration/deceleration of the device 900, and temperature changes of the device 900. The sensor component 914 may further include a proximity sensor configured to detect the presence of nearby objects without any physical contact. Moreover, the sensor component 914 may include a light sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the device 900 and other devices. The device 900 can access a wireless network based on a communication standard, such as WiFi, 2G, 3G, or a combination thereof. In one exemplary embodiment, the communication component 916 receives a broadcast signal or broadcast related information from an external broadcast management system via a broadcast channel. In another exemplary embodiment, the communication component 916 further includes a near-field communication (NFC) module to facilitate short-range communications. The NFC module, for example, may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components.

In exemplary embodiments, there is also provided a non-transitory computer-readable storage medium including instructions, such as included in the memory 904, executable by the processor 918 in the device 900, for performing the above-described methods. For example, the non-transitory computer-readable storage medium may be a ROM, a random access memory (RAM), a CD-ROM, a magnetic tape, a floppy disc, an optical data storage device, and the like.

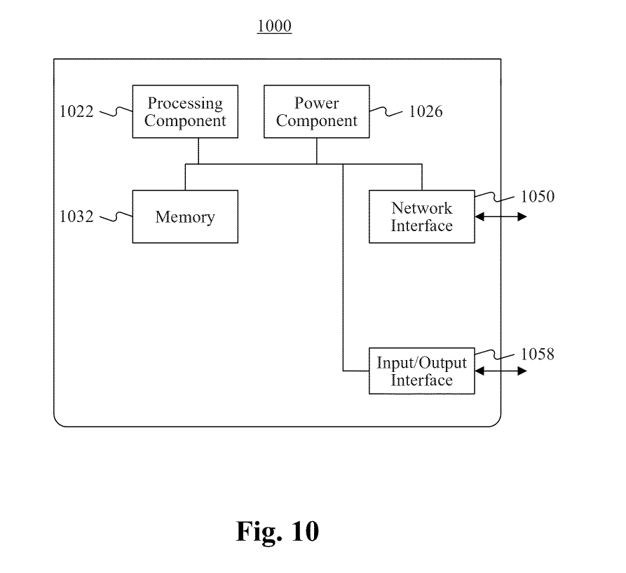

FIG. 10 is a block diagram of a device 1000 for sharing resources, according to an exemplary embodiment. For example, the device 1000 may be any of the above described resource-providing devices. Referring to FIG. 10, the device 1000 includes a processing component 1022 that further includes one or more processors, and memory resources represented by a memory 1032 for storing instructions executable by the processing component 1022, such as application programs. The application programs stored in the memory 1032 may include one or more modules each corresponding to a set of instructions. Further, the processing component 1022 is configured to execute instructions to perform the above method for sharing resources.

The device 1000 may also include a power component 1026 configured to perform power management of the device 1000, a wired or wireless network interface 1050 configured to connect the device 1000 to a network, and an I/O interface 1058. The device 1000 may operate based on an operating system stored in the memory 1032, such as Windows Server™, Mac OS X™, Unix™, Linux™, FreeBSD™, or the like.

In exemplary embodiments, there is also provided a non-transitory computer-readable storage medium including instructions, such as included in the memory 1032, executable by the processing component 1022 in the device 1000, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a resource-requesting device to request a shared resource from a resource-providing device, comprising:
accessing, via a browser installed on the resource-requesting device, a predetermined service address for sharing resources, the service address pointing to a web-service port of the resource-providing device;
receiving a list of shared resources sent by the resource-providing device, the list of shared resources including information regarding at least one shared resource;
presenting the list of shared resources in the browser for a user to select a target resource to access; and
accessing the target resource according to information regarding the target resource.

2. The method according to claim 1, wherein the presenting of the list of shared resources in the browser comprises:
arranging information regarding each shared resource included in the list of shared resources as a list item, the information regarding each shared resource including a resource name, a resource type, and a resource path of the shared resource; and
displaying the list of shared resources in the browser.

3. The method according to claim 1, wherein when the target resource is a folder, the accessing of the target resource according to information regarding the target resource comprises:
sending information regarding the folder to the resource-providing device via the browser;
receiving a file directory sent by the resource-providing device, the file directory including information regarding at least one file contained in the folder;
presenting the file directory in the browser for the user to select a target file to access; and
accessing the target file according to information regarding the target file.

4. The method according to claim 2, wherein when the target resource is a folder, the accessing of the target resource according to information regarding the target resource comprises:
sending information regarding the folder to the resource-providing device via the browser;
receiving a file directory sent by the resource-providing device, the file directory including information regarding at least one file contained in the folder;
presenting the file directory in the browser for the user to select a target file to access; and
accessing the target file according to information regarding the target file.

5. The method according to claim 1, wherein when the target resource is a file, the accessing of the target resource according to information regarding the target resource comprises:
sending information regarding the file to the resource-providing device via the browser; and
receiving the file sent by the resource-providing device.

6. The method according to claim 2, wherein when the target resource is a file, the accessing of the target resource according to information regarding the target resource comprises:
sending information regarding the file to the resource-providing device via the browser; and
receiving the file sent by the resource-providing device.

7. A method for a resource-providing device to provide a shared resource to a resource-requesting device, comprising:
monitoring the resource-requesting device's access to a predetermined service address for sharing resources, the service address pointing to a web-service port of the resource-providing device;
acquiring a list of shared resources including information regarding at least one shared resource; and
sending the list of shared resources to the resource-requesting device via the web-service port, so that the resource-requesting device presents the list of shared resources in the browser for a user to select a target resource to access.

8. The method according to claim 7, wherein the acquiring of the list of shared resources comprises:
acquiring a resource name, a resource type, and a resource path of each shared resource; and
determining resource names, resource types, and resource paths of the shared resources to be included in the list of shared resources.

9. The method according to claim 7, wherein when the target resource is a folder, the method further comprises:
receiving information regarding the folder sent by the resource-requesting device;
acquiring a file directory of the folder based on the information regarding the folder, the file directory including information regarding at least one file contained in the folder; and
sending the file directory for the resource-requesting device to present the file directory list in the browser for the user to select a target file to access.

10. The method according to claim 8, wherein when the target resource is a folder, the method further comprises:
receiving information regarding the folder sent by the resource-requesting device;
acquiring a file directory of the folder based on the information regarding the folder, the file directory including information regarding at least one file contained in the folder; and
sending the file directory for the resource-requesting device to present the file directory list in the browser for the user to select a target file to access.

11. The method according to claim 7, wherein when the target resource is a file, the method further comprises:
receiving information regarding the file sent by the resource-requesting device; and
sending the file to the resource-requesting device, the file being acquired based on the information regarding the file.

12. The method according to claim 8, wherein when the target resource is a file, the method further comprises:
receiving information regarding the file sent by the resource-requesting device; and
sending the file to the resource-requesting device, the file being acquired based on the information regarding the file.

13. A resource-requesting device, comprising:
a processor; and
a memory for storing instructions executable by the processor,
wherein the processor is configured to:
access, via a browser installed on the resource-requesting device, a predetermined service address for sharing resources, the service address pointing to a web-service port of a resource-providing device;
receive a list of shared resources sent by the resource-providing device, the list of shared resources including information regarding at least one shared resource;
present the list of shared resources in the browser for a user to select a target resource to access; and
access the target resource according to information regarding the target resource.

14. The device according to claim 13, wherein the processor is further configured to:
arrange information regarding each shared resource included in the list of shared resources as a list item, the information regarding each shared resource including a resource name, a resource type, and a resource path of the shared resource; and
display the list of shared resources in the browser.

15. The device according to claim 13, wherein when the target resource is a folder, the processor is further configured to:
send information regarding the folder to the resource-providing device via the browser;
receive a file directory sent by the resource-providing device, the file directory including information regarding at least one file contained in the folder;
present the file directory in the browser for the user to select a target file to access; and
access the target file according to information regarding the target file.

16. The device according to claim 14, wherein when the target resource is a folder, the processor is further configured to:
send information regarding the folder to the resource-providing device via the browser;
receive a file directory sent by the resource-providing device, the file directory including information regarding at least one file contained in the folder;
present the file directory in the browser for the user to select a target file to access; and
access the target file according to information regarding the target file.

17. The device according to claim 13, wherein when the target resource is a file, the processor is further configured to:
send information regarding the file to the resource-providing device via the browser; and
receive the file sent by the resource-providing device.

18. The device according to claim 14, wherein when the target resource is a file, the processor being further configured to:
send information regarding the file to the resource-providing device via the browser; and
receive the file sent by the resource-providing device.
